(19) United States
(12) Patent Application Publication
(10) Pub. No.: US 2006/0041731 A1
(43) Pub. Date: Feb. 23, 2006

(54) Method and device for persistent-memory mangement

(76) Inventors: Robert Jochemsen, Eindhoven (NL); Maarten Peter Bodlaender, Eindhoven (NL); Wilhelmus Franciscus Johannes Fontijn, Eindhoven (NL); Adrianus Johannes Maria Denissen, Eindhoven (NL); Nicolass Lambert, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/533,735

(22) PCT Filed: Oct. 13, 2003
(86) PCT No.: PCT/IB03/04564

§ 371 Date: May 4, 2005

(30) Foreign Application Priority Data
Nov. 7, 2002 (EP) 02079656.1

(51) Int. Cl. G06F 12/00

(52) U.S. Cl. 711/170; 711/112

(57) ABSTRACT

The present invention relates to a method for managing memory space of a persistent-memory device and to a memory management device. The memory management method of the invention comprises a step of allocating (S14) at least one first part of said memory space to a file system (74) upon request from said file system (74) or from an application (70). The method and the device of the present invention enable a dynamical allocation of persistent-memory space to a file system. This way, the memory space of a persistent memory is effectively used also for write-caching. At the same time, write-caching and storing steps can be accelerated.

The present invention relates to a memory management device and to a method for managing memory space of a persistent-memory device. It further relates to a method for write-caching in a persistent-memory device. It further relates to a method for saving data worked on by an application to a disk using a persistent-memory device. It also relates to a file system device, an application device, and a data processing system.

Persistent data storage is done in files. A file is a finite linear sequence of data, for instance data created and used by an application. In present data processing systems, files are stored persistently in secondary storage media which have slow access times for reading and writing in comparison with data processing speed. Examples of such secondary storage media are magnetic tapes or rotating hard disks, hereinafter also called disk, both having a magnetically writeable and readable coating. A disk contains equally sized blocks for data, called disk blocks or sectors. In a data processing system like a computer, a file system manages the persistently stored data. It allocates chains of disk blocks for files and writes to these blocks.

To enhance processing speed, a data structure worked on by an application is written to or loaded from the disk into a fast-access memory, also called random access memory (RAM), hereinafter also called working memory. Memory space in a working memory is allocated and managed by a memory manager.

The term application as used herein refers to a process or a device adapted to manipulate memory data. Data Manipulation includes for instance writing data to the memory, erasing data from the memory, transforming memory data, or storing memory data to a secondary storage medium. An application is implemented as a device in the form of one or a number of executable files loaded into a memory that is connected to a central processing unit, for instance in a computer. An application may as well be implemented as an integrated circuit, e.g., an Application Specific Integrated Circuit (ASIC) that is adapted to perform the mentioned process. Note that a file system and a memory manager are to be considered special cases of an application.

The structure of working data in the working memory is typically a number of memory blocks connected by pointers. For example, the working data structure in a memory can be in contiguous blocks or in blocks scattered over the working memory, with pointers linking the blocks in both cases. This structure of working data in the memory is optimised for programming ease-of use and for speed. It can differ significantly from the serial representation in a file, which usually needs to adhere to given, often proprietary standards.

Storing data from an application into a file on a disk therefore involves converting the data structure, on which the application works, to a file according to a predetermined conversion (serialisation) procedure. The serialisation procedure depends on the particular application creating the file, and is therefore performed by the application itself.

Access time to a disk for writing data from the working memory to a file on a disk is in the millisecond range. This is long in comparison with processing times consumed by microprocessors, micro controllers, digital signal processors (DSP), or the like. Therefore, disk access represents a bottleneck in the data processing flow.

To overcome the drawback of slow writing processes to disks, a write-cache memory with fast access times for writing is typically used to cache data to be stored on the disk. Caching means in present data processing systems that the working data structure is first copied to a fast-access write-cache memory. The write-cache memory, hereinafter also called cache memory, is separate from the working memory and keeps data in memory before it is written to the disk. Saving a file therefore involves conversion of working data to serialised data and writing the serialised data from the working memory to the write-cache memory, which is done by the application, and finally writing the serialised data from the write-cache memory to an assigned disk space, which is done by the file system.

The advantage of a write-cache memory is that it allows an application to initiate the persistent storage of a file on a disk without having to interrupt processing until the slow storing process on the disk is completed. As soon as the serialised data is secured in the cache memory, the file system sends a confirmation message to the application. After receiving the confirmation message, the application is ready to continue processing. Persistent storage on the disk is then managed by the file system. The application may be finished or continue working at the time or writing the file to the disk.

Two kinds of non-persistent cache memory are known: a block level cache and a file level cache. In a block level cache memory a file is kept in serialised data substructures that are adapted to the size of disk blocks and assigned to particular blocks on the disk. In a file-level cache memory, on the other hand, the file is kept as serialised data without a block-like substructure. The translation from the file structure to a disk block structure is postponed by the file system until it actually needs to write the data to the disk. Thus, in a file-level cache memory there is no assignment of the data to particular disk blocks before the actual process of writing to the disk is initiated. The file system only makes sure that the file data in the write-cache memory can be stored somewhere on the disk.

Serialising data in a working memory and storing the serialised data on a disk take significant time, during which the application cannot be sure that the data has been stored successfully. In addition, present memory devices, such as a Dynamic Random Access Memory (DRAM) device, rely on non-persistent data storage. Data in a non-persistent memory get lost in a system failure. Therefore, in a non-persistent write-cache memory data cannot be kept for a long time, since the risk of losing important data due to system failure is too high. Therefore, the described complex and time-consuming process for storing data worked on by an application has to be performed often in order to prevent data loss. This slows down the file system performance.

At present, persistent and at the same time fast working memory devices, such as Magnetoresistance-based RAM (MRA) devices, emerge from intensive world-wide research and development activities. A persistent-memory device remembers data stored in it even after a power down. Using this advantage of persistent memory, there have been attempts to improve the file system performance.

Wang et al. describe a disk/persistent-RAM hybrid file system in the document An-I A. Wang, P. Reiher, G. J. Popek, G. H. Kuenning, “Conquest: Better Performance Through a Disk/Persistent-RAM Hybrid File System”, available at http://www.lasr.cs.ucla.edu/awang/papers/usenix2002/camera2.htm. Their file system is built on the underlying assumption that persistent memory is available on a large scale in the Gigabyte range. The use of memory space or disk space for a file according to the file system of Wang et al. mainly depends on the size of the file. The file system of Wang et al. is based on the findings that most file access steps are to small files. In addition, small files make up the major part of files in a file system. A major part of the fast-access persistent-memory space is reserved for small files below 1 Megabyte, metadata, executables and shared libraries in persistent RAM. Metadata is data containing information on file data. An example for metadata is an i-node. An i-node holds administrative information on a file on the disk and the addresses of data blocks containing the file data on the disk. Therefore, slow access to disk-based larger files is limited to a smaller number of events. This way, according to Wang et al., the overall file system performance is enhanced with respect to access speed.

However, modern applications tend to produce larger and larger files due to an abundance of secondary storage space, i.e. disk space. Therefore, securing large amounts of application data on a disk remains a slow process in this file system. In addition, the assumption that there is an abundance of fast persistent-memory space does not apply to the majority of data processing systems that are commercially available today.

Miller et al. propose a file system using persistent RAM as a permanent storage medium for file system data and metadata (E. L. Miller, S. A. Brandt, D. D E. Long, “HeRMES: High-Performance Reliable MRAM-Enabled Storage, 8^{th} IEEE Workshop on Hot Topics in Operating Systems—HOTOS VIII, Schloss Elmau, Germany, May 2001). MRAM is also used as a write buffer in this file system. This allows postponing write processes to the disk for as long as desired without a risk of data loss due to system failure. However, this document does not disclose implications of the use of MRAM as a write buffer on persistent-memory management.

It is therefore an object of the present invention to provide a memory management device and a method for managing memory space of a persistent-memory device that allow to use a persistent-memory device as a write-cache memory.

It is another object of the invention to provide a method for write-caching that enhances the speed of securing application data.

It is a further object of the invention to provide a method for saving data worked on by an application to a disk that improves the file system performance with respect to speed.

It is a further object of the invention to provide file system with increased reliability that allows an application to avoid the bottleneck of writing processes to a secondary storage medium.

It is a further object of the invention to provide an application device that supports the memory management method and device of the invention.

It is a further object of the invention to provide a data processing system with enhanced file system performance.

In the following, to make an understanding of the invention easier, the invention will first be explained with respect to its method aspects, before the device aspects of the invention will be explained.

With respect to a method for managing memory space of a persistent-memory device, the object is achieved by a method for managing memory space of a persistent-memory device, comprising a step of allocating at least one first part of said memory space to a file system upon request from said file system or from an application.

According to the method of the invention, at least one part of the memory space of the persistent-memory device is allocated to a file system. Memory allocation is the process of assigning on request a part of memory space, such as a number of blocks. Allocation of memory space to a file system is unusual in memory management methods known in the art, because the prior art has considered the file system responsible for managing only persistent secondary storage space like disk space. According the the method of the invention, however, the file system can be assigned a part of the memory space of a persistent-memory device in addition to disk space. Thus, after the allocation step the storage space that is under the responsibility of the file system includes not only disk space, but also a part of the memory space of a persistent-memory device.

By assigning a part of the memory space to the file system according to the method of the invention, not only the respective memory space, but also data contained in this part of the memory space is handed over to the responsibility of the file system. Data in a memory space that has been allocated for an application up to the point in time of the request for allocation to the file system, is not accessible anymore for the application anymore after the allocation step has been performed. It becomes clear at this point, that the allocation step forms a basis for a new way of securing working data in a persistent-memory device. With the method of the invention, the persistent-memory device can be used as a working memory and as a write-cache memory.

According to the method of the invention, the allocation step is performed on a request from the file system itself or from an application. Thus, memory space is assigned to the file system on demand only. There is no a priori reservation of persistent-memory space for the file system. This allows an efficient use of fast-access persistent-memory especially when there is only a limited amount of such memory present. An application according to the present invention is considered any process run by a processing unit, such as an all-purpose central processing unit (CPU), an application specific integrated circuit (ASIC), a digital signal processor (DSP) or an application specific instruction set processor (ASIP). The process may be a subprocess of a more comprehensive application system such as a word processing application system. The application may specifically be represented by an executable file loaded to a working memory. The working memory containing the executable file may be a persistent memory, e.g., the same persistent memory as that managed by the method of the invention, or a non-persistent memory.

The memory management method of the invention therefore allows a dynamic allocation of file system memory space in a persistent-memory device. There is no a priori reservation of memory space for the file system. The memory space allocated for the file system depends on the current status of the memory.

Thus, depending on the current status of the memory and of a data processing system using the memory, the complete memory space may be under the control of a memory management unit, which may perform a conventional memory method according to principles known in the art as long as there is no request to allocate memory space to the file system. As soon as a request for allocation of a part of the memory space for the file system is received by the memory management unit, the memory space available for such conventional memory management is reduced by that part.

The method of the invention thus forms a method of using the memory space of a persistent-memory device as a fast-access working memory and a fast-access file system memory, such as a file system write-cache memory. The same memory space may at one moment in time be allocated for an application, at a later moment be allocated to the file system, and still later be allocated to the same or another application.

Of course, the method of the invention may be used to manage the memory space of a plurality of persistent-memory devices. The memory space to be managed is the sum of the memory spaces of each persistent-memory device and may be treated (addressed) as one logical memory space.

There may be more than one part of the memory space of the persistent-memory device allocated for the file system in one allocation step. This is typically the case when there are two or more groups of working data in a working memory formed by the persistent-memory device, that are worked on in parallel by the same application. If the application requests securing both groups of working data, e.g., just before the application is finished, the allocation step may include both parts of the memory space that contain the two groups of working data. Of course, these groups of data may also be secured one after another if speed is no issue.

There may be a preset upper limit of memory space, such as a number of Megabytes that can be allocated for the file system in order to avoid a situation in which memory space needed as working memory becomes sparse and system performance becomes slow.

In a first preferred embodiment of the memory management method of the invention the allocating step comprises a step of blocking a writing access to the first part of the memory space. By this step, data contained in that part of the memory space are secured, i.e., protected against any writing access, be it from an application or from the file system.

In a further embodiment the allocating step comprises a step of giving away to the file system the power of reading access to said first part of said memory space. This way the responsibility for the data contained in the first part of the memory space is completely handed over to the file system. Any reading access to the data will have to be managed by the file system after this step. This corresponds to a situation known from conventional data processing systems in which working data have been written to the disk. However, in the present embodiment the data may not have been written to the disk yet and is still save even in the case of a system failure. An application requesting access to these data does not see a difference to data stored conventionally on a disk. The present embodiment allows the application to have a fast access to the data via the file system after a restart, for instance in the case of a system breakdown. Thus, the present embodiment is advantageous for write-caching in a permanent memory. There is no need to perform a step of writing to a disk immediately after securing the data in the persistent memory by the allocation step. The step of writing to a disk may be postponed to a later stage without any risk of data loss. An application is sure that the working data has been secured just as in a conventional disk access step immediately after the successful performance of the allocation step of the present embodiment.

Another preferred embodiment of the memory management method of the invention comprises a step of deallocating said first part of said memory space to said memory manager. In this embodiment, the file system “gives back” to the memory manager the memory space that has been allocated to the file system. This way the memory space is free to be used as working memory again. It may be allocated to another application.

The allocating step and/or the deallocating step preferably comprises transmitting an address or address range defining the first part of said memory space. An address range may be defined by a first and a second address, each representing a respective memory cell of the persistent-memory device. The address range will then include all memory cells having addresses between the first and the second address. In the allocation step the transmission is from the memory manager to the file system. The file system can then include the received address range in its file allocation system, such as a file allocation table, or in a separate cache-memory data allocation table. The memory manager preferably marks the transmitted address range as allocated for the file system to avoid erroneous double allocation of the same memory space. In the reallocation step the transmission is from the file system to the memory manager. The file system will erase the address range from its allocation table or mark it as not accessable. The memory manager will mark the transmitted address range as free for recycling, i.e., a new allocation to either the file system or an application.

In a further preferred embodiment, the deallocating step is performed for said first part of said memory space given the condition that first data contained in that part of the memory space is stored in the form of file data in a second part of the memory space of the persistent-memory device. This embodiment is advantageous in a process of saving working data to a file. Once the first data is saved in the persistent-memory device in the form of a file structure and the second part of the memory space is allocated to said file system, the data is safe. Therefore, the original working data structure of the first data need not be kept in the persistent memory anymore. The first part of the memory may be deallocated. The memory manager is then free to recycle this part in a new allocation step. Note that this embodiment only applies to the case in which the first part of the memory has been allocated to the file system before.

In a further embodiment of the-memory management method of the invention the deallocating step is performed for said second part of the memory space given the condition that the file data has been written to a secondary storage medium. This embodiment is advantageously applied in a situation where data are stored on a disk. After a successful step of writing the file data to the disk there is no need to secure the file data in the persistent memory as well. The second part of the memory space may therefore also be deallocated to the memory manager, in just the same way as described above for the first part of the memory space.

According to a second aspect of the invention the above-described method of managing the memory space of a persistent memory device is used for write-caching on the persistent memory device. This invention is a method for write-caching first data worked on by an application, said first data being contained in a first part of a memory space of a persistent-memory device. The method of the invention comprises a step of performing a memory managing method according to the first aspect of the invention or any of its embodiments.

According to the method of the present invention, write-caching is performed by allocating to a file system a memory space that has been allocated to an application. As explained above in the context of the description of the memory management method of the invention, this allocation step is performed only upon a request from the application working on the first data or the file system. This allows to avoid unwanted blocking of working data that would interfere with the application.

The present write-caching method introduces caching at an even higher level than a file-level cache. Control over the first data representing working data in the first part of the persistent working memory is handed over to the file system, thus creating a temporary extension of a file system representing a file system write-cache memory. The data contained in the first part of the persistent memory are secured from any further writing access as soon as the allocation step of the memory management method has been performed successfully. The data can subsequently be written to a secondary storage medium such as a disk. The step of writing to the disk can be postponed to a convenient time without any risk of losing data due to a system failure. If necessary, the working data can first be transformed into a file structure as will be described below in the context of a preferred embodiment. By this method, the speed of securing working data in a write-cache memory is enhanced considerably in comparison with known write-caching methods.

A preferred embodiment of the write-caching method of the invention comprises, after said allocating step, a step of sending a confirmation message from the file system to the application. The confirmation message may in an alternative embodiment be sent by the memory manager instead of the file system after the allocation step. The confirmation message tells the application that the data are secured. For instance, if working data are to be stored when finishing the application, the application may be shut down immediately after receiving the confirmation message.

In a further preferred embodiment of the write-cache method of the invention the first data is a copy of third data contained in a third part of the memory space of the persistent-memory device. This describes a situation when an application continues to work on the third data in the third part of the persistent memory, but there has been a command from the application to secure the current status of the third data in a file. In this embodiment the write-caching method comprises, before performing said memory managing method, a step of copying the third data to the first memory space. The first data therefore represents a status of the working data at the time of the mentioned command.

This embodiment is especially important, because it is used in the working progress of the application. This embodiment also clearly shows the advantage of the write caching method of the invention. The application may continue to work on the third data as soon as it is copied to the first part of the memory space and the allocation step has been performed with respect to this first part of the memory space. Writing the first data to the disk may be performed at a later time due to the persistent nature of the memory.

The mentioned copying step preferably comprises a step of allocating the first part of the memory space to the application for the copy of the third data, and a step of writing this copy of the third data to the first part of the memory space.

A further preferred embodiment of the write-caching method of the invention applies to situations where the first data has a working data structure that differs from a file structure. Not all working data structures necessarily differ from a file structure. This depends on the particular application. In general, however, there working data in the first part of the memory do not exhibit a linear structure according to the standards of the particular application. In this case the present embodiment of the write-caching method comprises a step of allocating a fourth part of the memory space to the application for an executable file that is adapted to converting the first data into file data, a step of writing the executable file to the fourth part of the memory space, and a step of allocating the fourth part of the memory space to the file system.

In this embodiment, the application hands over to the file system the routine for transforming working data to the application-specific file structure. In an alternative to this embodiment the routine is stored in the file system already, and the application passes a reference to this routine to the file system. In both alternatives, the routine has the form of an executable file, or, preferably, of a dynamically linked library (dll). It is noted, that in general, anything executable may be used here, such as an executable code just created by executing another executable code. In the preferred case of a dll, the file system can subsequently call a predefined function of the dll, passing a pointer to the memory to transform. In both embodiments, as a result, the transformation of the working data into file data is then in the responsibility of the file system, not in the responsibility of the application. The file system can wait with the transformation up to a convenient point in time or until the transformation is necessary. The application does not have to deal with the transformation and can continue to work on the data in the third part of the memory space. This way the time spent by the application for securing the working data is reduced. Therefore, the application speed is enhanced.

In this embodiment, the step of writing the executable file to said fourth part of said memory space is preferably initiated by the application itself. Most preferably, this is done at the same time or immediately after the command to secure the data has been given by the application.

The executable file for transformation need only once be handed over to the file system. After that, as long as the application is active, the file system may keep the transformation routine and the associated fourth memory space under its responsibility. Alternatively, it is also possible that the transformation routine is transferred to the file system with every write-caching. The lattter alternative will be advantageous if persistent memory space is sparse while the further alternative is to be preferred when the processing load due to the data storage is to be reduced. In both alternative cases, after said transforming step or after said finishing step, respectively, a step of deallocating the fourth part of the memory space to said memory manager is performed. This way, the memory manager can allocate the memory space to another application.

As a further alternative the file system may keep the transformation routine even for a longer time than the application is active. By keeping the transformation routine in the fourth part of the persistent-memory space under the responsibility of the file system the write-caching speed is further enhanced. This is especially useful in a data processing system which is adapted to run only one application or application system. On the other hand, this alternative method will only be useful if there is sufficient persistent memory space and keeping the routine in the memory does not impair the performance of the working memory.

The step of transforming the first data into file data with the aid of said executable file preferably comprises the steps of allocating the second part of the memory space to the executable file for said file data, creating the file data by applying the executable file to the first data, writing said file data to the second part of the memory space, and allocating said second part of said memory space to said file system. Reference is made to the explanation of the memory management method of the invention, in which the terms of the second part of the memory space and the file data were introduced. These terms are used here again for reasons of consistency.

Initiating the transforming step is by the file system has the advantage that unnecessary transformation steps can be avoided. Often times applications have automatic routines of securing data after a predetermined time span calculated from the last securing action. If the application is not finished, the working-data copy in the first part of the memory space may simply be overwritten without having transformed the previous copy into file data. This way the processing load is further reduced, again making use of the persistent nature of the memory space that does not bear the risk of data loss.

According to a third aspect of the invention the above-described write-caching method is used in the context of a method for saving data worked on by an application to a file on a secondary storage medium. This file-saving method comprises the steps of performing a write-caching method according to the second aspect of the invention or any of its embodiments described above, and writing the file data to the secondary storage medium.

The file saving method of the invention exhibits an increased reliability in that data to be written to the disk is secured immediately after the allocation step involved in the memory management method that is performed during write-caching. Furthermore, the use of the write-caching method in the file saving method of the invention allows an application to avoid the bottleneck of writing processes to a secondary storage medium. The application only uses fast-access write processes to the persistent memory and receives a confirmation message as soon as the just mentioned allocation step has been successfully performed. The actual writing to the disk is independently managed by the file system at a convenient time, for instance, when the application does not need the full processing capacity of the processing unit.

Writing file data to the disk may follow known procedures. In a preferred embodiment, the data saving method comprises, before said writing step, a step of splitting the file data in to file data blocks in order to adapt the data structure in the persistent memory to the structure of the storage medium on the disk. The splitting step preferably comprises uniquely assigning each of the file data blocks to a sector of said disk. Finally, the writing step preferably comprises writing each file data block to the respective assigned sector of said disk.

According to a fourth aspect of the invention a memory management device for managing memory space of at least one persistent-memory device is provided. The memory management device comprises a memory allocation unit adapted to communicate with at least one application device and to allocate at least one first part of said memory space of a persistent-memory device to the application device. According to the invention, the allocation unit is further adapted to communicate with at least one file system device, and to allocate on request from said application device or from said file system device a first part of the memory space to said file system.

The memory management device, sometimes also referred to as memory management unit, of the invention is adapted to perform a memory management method according to the first aspect of the invention or any one of its embodiments. For this purpose, the allocation unit is modified in comparison with known memory management devices. The memory management device of the invention may be provided, for instance, in the form an integrated circuit such as an ASIC. On the other hand, it may also be provided in the form of an executable file that is loaded to a working memory connected to a processing unit. In particular, the working memory that contains the executable file may be the persistent memory device, that is under control of the memory management device.

The memory management device of the invention is in a preferred embodiment adapted to maintain a memory allocation table. The memory allocation table assigns at least one memory address representing a defined part of the memory space of a persistent-memory device to either said application device or to said file system device. The conditions under which allocation to the file system or the application is made, respectively, have been described in the context of the memory management method of the invention. Reference is therefore made to the corresponding part of the present description.

According to a fifth aspect of the invention, a file system device is provided, comprising a file allocation unit adapted to maintain a file allocation table at a current status, said file allocation table assigning at least one disk space address to at least one file. The file allocation unit is adapted to communicate with a memory management device related to a persistent-memory device. Further, the file allocation unit is adapted to include an address of at least one first memory space of said persistent-memory device in the maintenance of said file allocation table.

The file system of the present aspect of the invention is adapted to work with a memory management device as described above and to be used in the file saving and write-caching methods of the invention.

The file system device may, in a similar way as the memory management device, be provided in the form of an integrated circuit. It may, as an alternative further comprise a processor and a memory, and the file allocation unit is implemented in the form of at least one second executable file contained in said memory. Processor and memory may, as above, be shared with another device, such as the memory management device or one or several application devices.

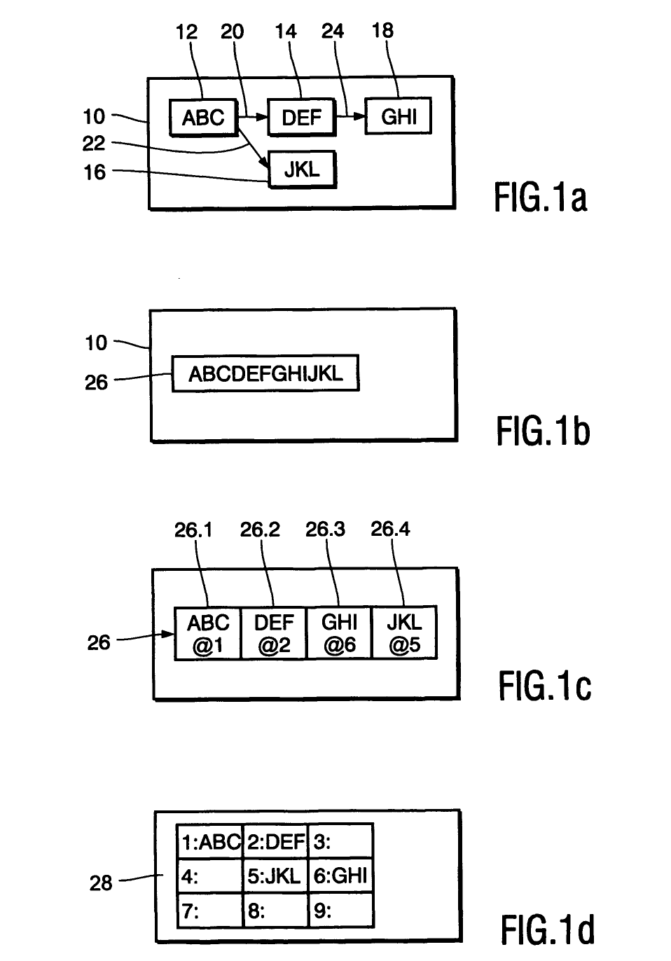

According to a sixth aspect of the invention, an application system is provided, comprising a persistent-memory device connected to a processor, and a data management unit adapted to manipulate data in said persistent memory device. The data management unit is adapted to write at least one third executable file or dll to said persistent memory, such that by executing said third executable file or dll said processor is adapted to transform said data into a predetermined data-sequence form, i.e. to create file data from working data as described above in the context of the method of the invention and as will be described in further detail below with reference to FIG. 1. The data management unit is adapted to write an executable file to a persistent-memory device, said executable file containing a transformation routine adapted to transform a data structure contained in a persistent-memory device into a linear sequence of data. Alternatively, the data management unit is adapted to provide the file system with a reference to such an executable file or dll that is already contained in the file system.

The application device of the invention differs from known application devices in that it is adapted to let the file system of the invention perform the transformation of working data into file data. The application device of the invention may take the form of an integrated circuit or one or a plurality of executable files loaded into a working memory of a data processing system such as a computer.

The application device can be a machine specifically designed for a particular application, such as a computer integrated manufacturing (CIM) device or an embedded application. It may as well take the form of a home or office computer equipped with an application program that comprises the data management unit just mentioned.

Therefore, according to a seventh aspect of the invention, a storage medium containing at least one of the mentioned executable files is also comprised by the present invention. The storage medium may take the form of a disk, a compact disk, a digital versatile disk or any other data storage medium, such as a permanent memory device. The invention is also in a persistent memory device containing a code representing a memory management method of the invention.

Finally, according to an eighth aspect of the invention a data processing system is provided, comprising a memory management device according to the invention, a file system device according to the invention, an application device according to the invention, and/or a storage medium according to the invention.

In the following, the present invention will be described in greater detail based on preferred embodiments with reference to the figures, in which:

FIG. 1a shows a persistent memory with working data,

FIG. 1b shows the persistent memory of FIG. 1a with the working data of FIG. 1a in a file structure

FIG. 1c shows the persistent memory of FIG. 1b with the working data of FIG. 1b split into file data blocks

FIG. 1d shows a disk containing the file data blocks of FIG. 1c

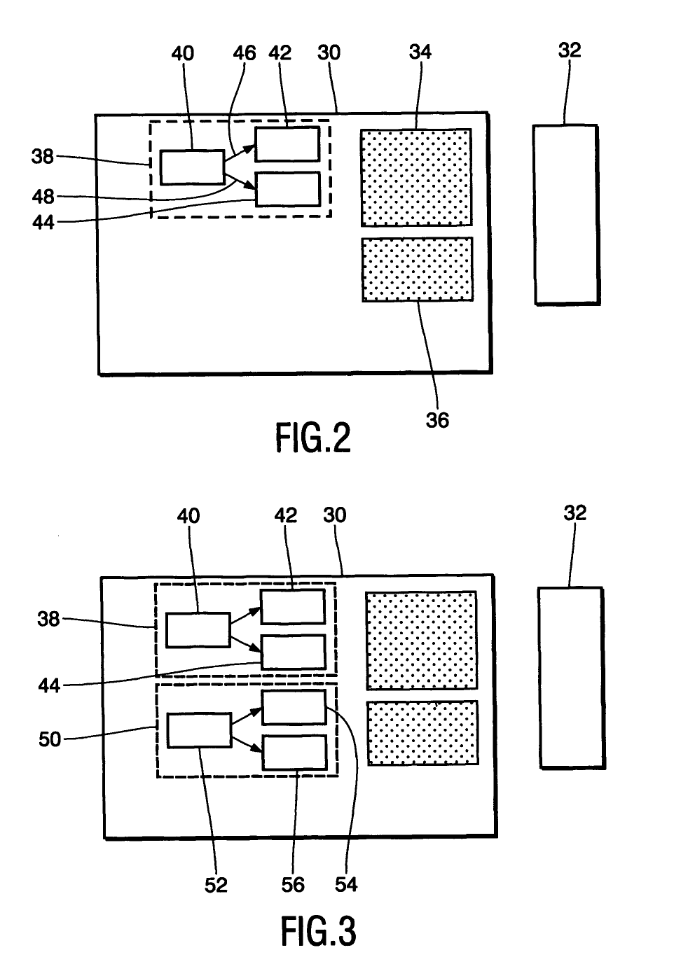

FIGS. 2 to 7 show a persistent memory and a disk at different stages of a file saving process according to an embodiment of the invention

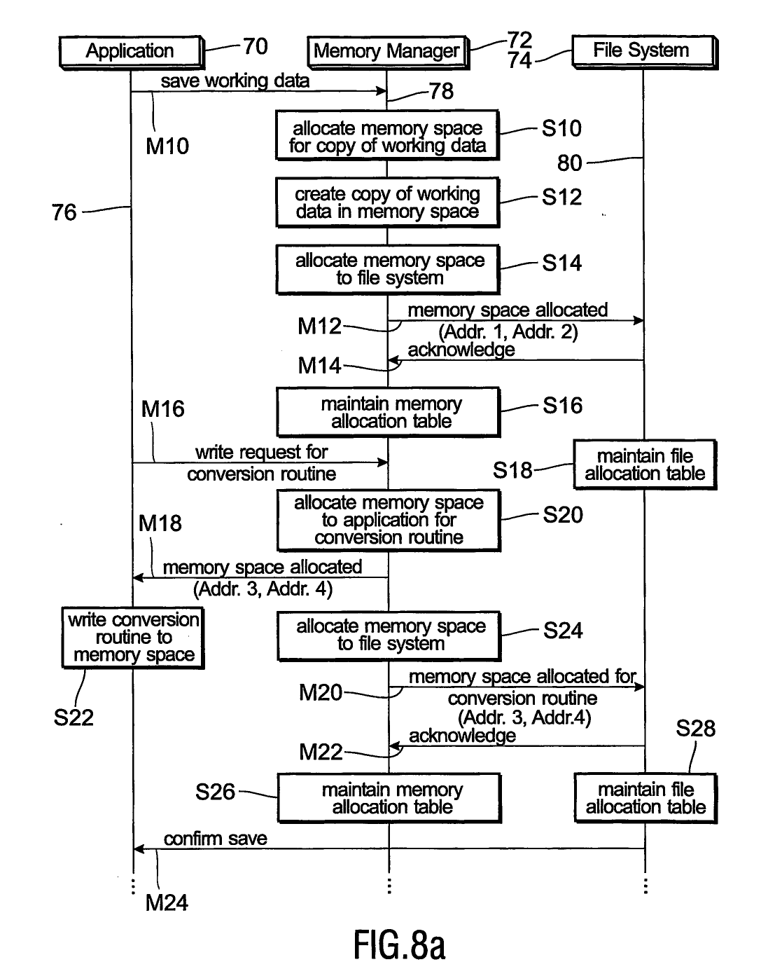

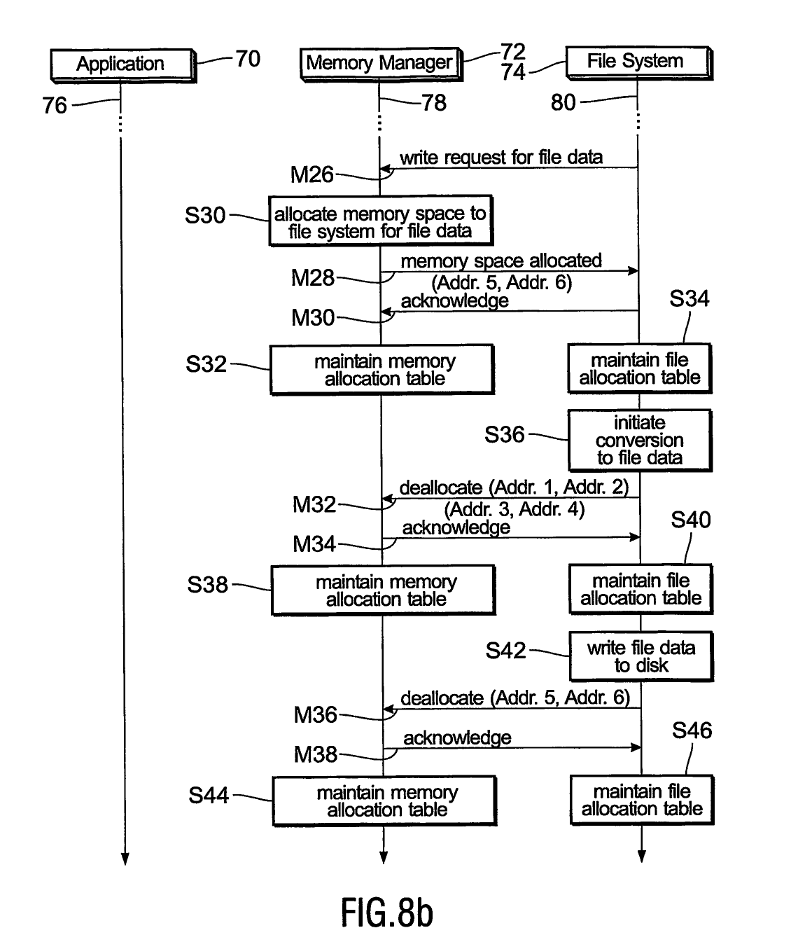

FIGS. 8a and b show a flow diagram containing the message flow between an application, a memory manager and a file system during a file saving process according to an embodiment of the invention.

FIG. 1a shows a persistent memory 10 containing a working data structure created by an application. The working data is represented by capital letters A through L contained in four memory blocks 12 through 18. The memory blocks are linked by pointers which are shown as arrows 20 through 24. The working data of FIG. 1a exhibit a structure that deviates from a linear structure expected from a file. Memory block 12 is linked to memory blocks 14 and 16 in parallel by two pointers 20 and 22. Such a parallel structure cannot be represented in a file, which must contain a linear sequence of data.

FIG. 1b shows the persistent memory 10 of FIG. 1a. In FIG. 1b the working data structure of FIG. 1a has been copied and transformed into a sequence of working data contained in a memory block 26. The memory blocks 12 through 18 have been recycled. For transformation of the working data structure 12 through 18 into the file structure 26 an application-specific conversion routine has been used that is not shown in this figure.

FIG. 1c shows the persistent memory 10 with the file structure 26 split into file data block 26.1 through 26.4. Each file data block contains a set of data represented by letters again. For example, file data block 26.1 contains the data A, B, and C. In addition, each data block contains an assignment to a sector on a disk 28 shown in FIG. 1d. An assignment is represented in this figure by an “@”-Symbol and a disk block address shown as a number. For example, file data block 26.3 containing the data G, H, and I is assigned to a file sector 6. The assignment of the file data blocks to particular disk sectors is performed by a file system not shown in this figure.

FIG. 1d shows a disk 28 with file sectors having file sector addresses 1 through 9. The file sectors 1, 2, 5, and 6 contain the data A through L. The situation shown here is that after a step of writing the file data blocks 26.1 through 26.4 of FIG. 1c to their respective assigned disk sectors. Disk sectors 3, 4, 7, 8 and 9 remain free for allocation by the file system for the time being.

The sequence of FIGS. 1a to 1d thus shows the persistent memory 10 and the disk 28 at different stages of a process of saving working data created by an application in the persistent working memory 10 to the disk 28. The sequence of stages shown here would not differ when using a non-persistent memory instead of the persistent memory 10.

FIGS. 2 to 7 show a memory space 30 of a persistent-memory device and a disk space 32 of a disk drive at different stages of a file saving process according to an embodiment of the invention. The persistent memory 30 contains two blocks 34 and 36 that are dot-hatched. Dot-hatched memory blocks in this and the following figures indicate that the respective memory blocks are under the control of the file system, and not of the memory manager. Control over memory blocks of the persistent memory space 30 is handed over from the memory manager by an allocation step according to the method of the invention described below with reference to FIG. 8.

The memory space 30 further contains a section 38 with three blocks 40, 42, and 44 containing working data. This working data structure 38 corresponds to that shown in FIG. 1a. Working data block 40 is linked to block 42 and 44 in parallel by pointers 46 and 48, again shown as arrows in this figure. The situation shown in FIG. 2 represents a stage at which an application is working on the data structure 38. Blocks 34 and 36 are assigned to the file system. They may for instance contain conversion routines for transforming a working data structure into a file structure to be used with different applications than that currently running.

FIG. 3 represents a later stage of the same system. Since the same system is shown, the same reference numbers are used for elements identical to those of FIG. 2. A second working data structure 50 has been written to the memory space. This working data structure is a copy of the working data structure 38. Its data blocks 52, 54, and 56 contain a copy of the working data blocks 40, 42, and 44, respectively. The situation shown in FIG. 3 corresponds to a stage of a process of saving data to the disk 32 at which the application has given a “save to disk”-command. The status of the working data structure 38 at the point in time of the “save to disk”-command has been written to the data structure 50.

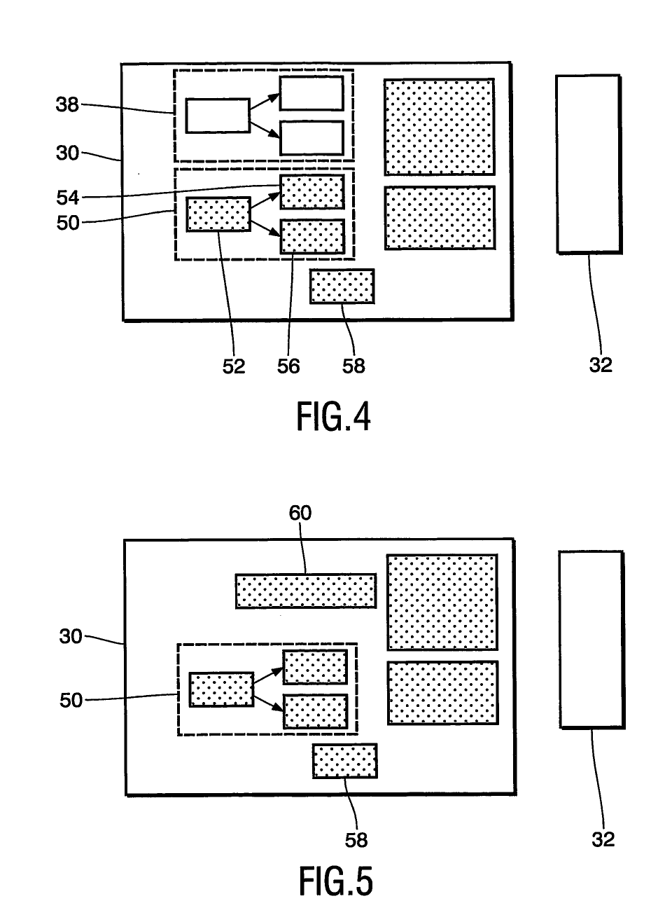

FIG. 4 represents a later stage of the same system in the saving process. At this stage, control over the second working data structure 50 has been handed over to the file system. This is indicated in FIG. 4 by the dot-hatched memory blocks 52, 54, and 56. In addition the application has handed over to the file system a conversion routine for transforming the working data structure 50 into a file data structure. The conversion routine is stored in a memory block 58. In an alternative embodiment, the conversion routine may have been read from the disk 32 and loaded into block 58 of the persistent-memory 30. The original working data structure is still present at this stage.

FIG. 5 represents a later stage of this system. The file system has applied the conversion routine to the working data structure 50. A file data structure created this way in a memory space 60 that is allocated by the memory manager to the file system. The memory range 38 containing original working data blocks 40, 42, and 44 (cf. FIGS. 2 to 4) has been deallocated from the file system to the memory manager. For the working data structure 39 has been secured at the point in time when the file system has the copy 50 of the working data structure 38 and the conversion routine 58. It is at that point that the file system confirms success of the saving process to the application. The memory manager is free to allocate this memory range to another application or to the file system. Obviously, a part of the memory range 38 has been allocated to the file system for storing the file data structure 60.

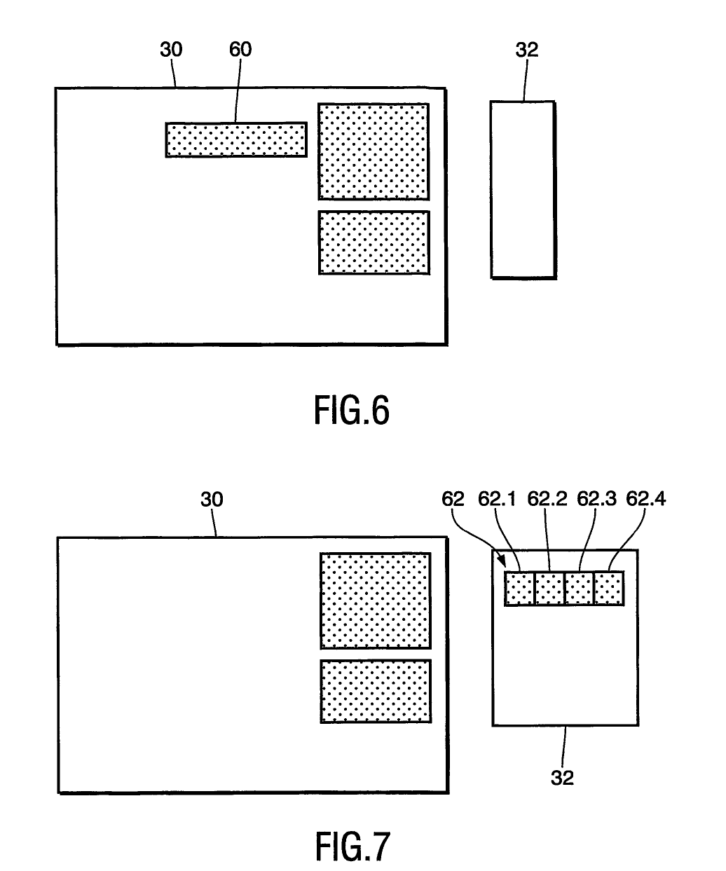

FIG. 6 represents a later stage of this system. At the stage shown here, from the data related to the ongoing saving process only the file data structure 60 is kept in the persistent memory space 30. The memory range 50 and the block 58 have been deallocated to the memory manager. They are not needed in the further progress of the current saving process.

FIG. 7 represent the final stage of the system in the saving process. The file data structure 60 has been written to the disk 32. Therefore, the pertaining memory blocks are deallocated to the memory manager. The disk 32 now contains a file 60 that is stored in four disk sectors 62.1 through 62.4.

FIG. 8a and b show in a flow diagram the method steps performed and the messages exchanged by an application 70, a memory manager 72 and a file system 74 during a process of saving working data in a persistent memory to a file on a disk according to an embodiment of the invention. The whole process extends over both FIGS. 8a and 8b. It is splitted only due to the limited paper size.

The method steps taken by the application 70 are shown along a left time line 76. The method steps taken by the memory manager 72 are shown along a middle time line 78.

The method steps taken by the file system 74 are shown along a right time line 80. Messages exchanged between the application, the memory manager and the file system, respectively, are represented by horizontal arrows originating at the unit sending the message and pointing to the message receiving the message. Messages will in the following be referred to using reference signs beginning with an M followed by a number. Method steps will be referred to using reference signs beginning with an S followed by a number.

The saving process of the present embodiment is started by a saving command M10 sent from the application 70 to the memory manager 72. The memory manager will then react to the command in a step S10 by allocating a memory space for a copy of the working data that are to be saved on the disk. Then, the copy of the working data will be written to the allocated memory space in a step S12. In the present embodiment this step is performed by the memory manager. However, this step may as well be performed by the application 70. In a further step S14 the memory space containing the copy of the data (i.e., the “first part of the memory space” in the terminology used above) will be allocated to the file system. It is noted that the memory manager allocates the memory space on request of the application. This request is implicitly contained in the save message M10.

The allocation is then reported to the file system by a message M12 containing also the address range of the allocated memory space indicated by a first address (“Addr.1) and a second address (Addr. 2). The file system acknowledges receipt of message M12 in a step M14.

The memory manager will then in a step S16 maintain a memory allocation table in order to make sure that the memory space allocated to the file system cannot be allocated to another application. The file system, on the other hand, will in a step S18 maintain a file allocation table (FAT) in order to include the allocated memory space therein.

At any time after sending the message M10, or with sending the message M10, the application will in a message M16 request memory space from the memory manager for a conversion routine that transforms working data into file data. The memory manager 72 will allocate memory space to the application in a step S20 and report to the application in a message M18, containing the allocated address range from Address 3 to Address 4. In a step S22 the application writes the conversion routine to this allocated memory range.

This memory range containing the conversion routine will then in a step S24 be allocated to the file system. The allocation is reported to the file system in a message M20. The file system 74 acknowledges the allocation in a message M22. Then, in steps S26 and S28 the memory manager maintains the memory allocation table and the file system maintains the file allocation table as described before.

In a message M24 the file system will then confirm the successful securing of the working data to the application.

The further progress of the saving method will now be described with reference to FIG. 8b. In a message M26 the file system requests from the memory manager the allocation of memory space for file data that are to be created from the working data using the conversion routine that is now under the control of the file system. In a step S30 the memory manager will allocate the requested memory space from Address 5 to Address 6 and report to the file system correspondingly in a message M28. The file system will acknowledge with a message M30. Again, memory manager and file system will maintain their respective allocation tables in steps S32 and S34.

Then the file system initiated the conversion of the working data in the memory space from Address1 to Address2 allocated to the file system in S14 to file data in a step S36. It is up to the file system to wait with step S36 for a convenient time, depending, for instance, on the current processing load. The file data will be written to the allocated memory range from Address5 to Address6. At this time, the file system requests reallocation of the memory spaces containing the copy of the working data (Address1 to Address2) and the conversion routine (Address3 to Address4) in a message M32. There may in an alternative embodiment be separate messages for each memory space mentioned. The file system acknowledges receipt of the reallocation request in a message M34 and will maintain its memory allocation table in a step S38. At this point, the mentioned memory space ranges are under the control of the memory manager again. The file system maintains its file allocation table in a step S40. In a step S42 the file system initiates writing the file data to the disk. Writing the file data to the disk comprises all the steps indicated with reference to FIGS. 1c and d.

When the file data is stored to the disk the file system requests from the memory manager the reallocation of the memory space containing the file data in a message M36. The memory manager acknowledges with a message M38. Memory manager and file system maintain their allocation tables in steps S44 and S46. This completes the saving method of the present embodiment using a persistent memory device as a write cache memory.

1. A memory management device for managing a memory space of at least one persistent-memory device, comprising a memory allocation unit adapted to communicate with at least one application device and to allocate at least one first part of said memory space to said application device, wherein said allocation unit is further adapted to communicate with at least one file system device, and to allocate on request from said application device or from said file system device said first part of said memory space to said file system.

2. A memory management device according to claim 1, wherein said memory allocation unit is adapted to maintain a memory allocation table at a current status, said memory allocation table assigning at least one memory address representing a defined part of said memory space to either said application device or to said file system device.

3. A memory management device according to claim 2, further comprising a processor and a memory, wherein said memory allocation unit is implemented in the form of at least one first executable file contained in said memory.

4. A memory management device according to claim 3, wherein said memory is a persistent-memory device, in particular said persistent-memory device.

5. A file system device, comprising a file allocation unit adapted to maintain a file allocation table at a current status, said file allocation table assigning at least one disk space address to at least one file, wherein said file allocation unit is adapted to communicate with a memory management device that is related to a persistent-memory device and to include an address of at least one first memory space of said persistent-memory device in the maintenance of said file allocation table.

6. A file system device according to claim 5, further comprising a processor and a memory, wherein said file allocation unit is implemented in the form of at least one second executable file contained in said memory.

7. An application device, comprising a persistent-memory device connected to a processor, and a data management unit adapted to manipulate data in said persistent memory device, wherein said data management unit is adapted to write at least one third executable file to said persistent memory device, or to provide the file system with a reference to at least on third executable file in said file system, such that by executing said third executable file said processor is adapted to transform said data into a predetermined data-sequence form.

8. An application device according to claim 7, wherein said data management unit is provided in the form of least one fourth executable file in a memory, particularly, in said persistent memory.

9. A storage medium containing said first executable file according to claim 3.

10. A data processing system, comprising a memory management device for managing a memory space of at least one persistent-memory device, comprising a memory allocation unit adapted to communicate with at least one application device and to allocate at least one first part of said memory space to said application device, wherein said allocation unit is further adapted to communicate with at least one file system device, and to allocate on request from said application device or from said file system device said first part of said memory space to said file system.

11. A method for managing memory space of a persistent-memory device, comprising a step of allocating at least one first part of said memory space to a file system device upon request from said file system device or from an application device.

12. A method according to claim 11, wherein said allocating step comprises a step of blocking a writing access to said first part of said memory space.

13. A method according to claim 12, wherein said allocating step comprises a step of giving away to said file system device the power of reading access to said first part of said memory space.

14. A method according to claim 11, comprising a step of deallocating said first part of said memory space to a memory management device.

15. A method according to claim 11, wherein said allocating step or said deallocating step comprises transmitting an address range defining said first part of said memory space from said memory management device to said file system device or, respectively, vice versa.

16. A method according to claim 14, wherein said deallocating step is performed for said first part of said memory space given the condition that first data contained in said first part of said memory space is stored in the form of file data in a second part of said memory space, said file data having a predetermined file structure, and
that said second part of said memory space is allocated to said file system device.

17. A method according to claim 16, wherein said deallocating step is performed for said second part of said memory space given the condition that said file data has been written to a secondary storage medium.

18. A method for write-caching first data worked on by an application, said first data being contained in a first part of a memory space of a persistent-memory device, comprising a step of performing a memory managing method according to claim 17.

19. A write-caching method according to claim 18, comprising, after said allocating step, a step of sending a confirmation message from said file system device to said application device.

20. A write-caching method according to claim 18, wherein said first data is a copy of third data contained in a third part of said memory space, said write-caching method comprising, before performing said memory managing method, a step of copying said third data to said first memory space.

21. A write-caching method according to claim 18, comprising the steps of
allocating a fourth part of said memory space to said application device for an executable file or dynamic link library that is adapted to converting said first data into file data
writing said executable file or dynamic link library to said fourth part of said memory space
allocating said fourth part of said memory space to said file system device.

22. A write-caching method according to claim 21, comprising a step of transforming said first data into said file data with the aid of said executable file or said dynamic link library.

23. A write-caching method according to claim 22, wherein said transforming step is initiated by said file system device.

24. A write-caching method according to claim 23, comprising, after said transforming step, a step of deallocating said fourth part of said memory space to said memory management device.

25. A method for saving data worked on by an application device to a file on a secondary storage medium, comprising the steps of
Performing a write-caching method according to claim 18,
Writing said file data to said secondary storage medium.
